(19) United States
(12) Patent Application Publication
(10) Pub. No.: US 2026/0012299 A1
(43) Pub. Date: Jan. 8, 2026

(54) ON-OFF KEYING-MODULATED ORTHOGONAL FREQUENCY DIVISION MULTIPLEXING WAVEFORM GENERATION

(71) Applicant: QUALCOMM INCORPORATED, San Diego, CA (US)

(72) Inventors: Wei Yang, San Diego, CA (US); Jing Lei, San Diego, CA (US); Zhikun Wu, Beijing (CN); Yuchul Kim, San Diego, CA (US); Ahmed Elshafie, San Diego, CA (US); Peter Gaal, San Diego, CA (US); Krishna Kiran Mukkavilli, San Diego, CA (US)

(21) Appl. No.: 18/992,829

(22) PCT Filed: Aug. 17, 2022
(86) PCT No.: PCT/CN2022/112982

§ 371 Date: Jan. 9, 2025

(51) Int. Cl. H04L 5/00; H04L 27/26; H04W 72/044

(52) U.S. Cl. CPC H04L 5/0007; H04L 27/2678; H04W 72/044

(57) ABSTRACT

Methods, systems, and devices for wireless communications are described. A transmitter may modulate a set of bits into an on-off keying (OOK) sample sequence for wireless transmission to a receiver in a set of frequency resources. The transmitter may apply a transform (e.g., a discrete Fourier transform (DFT)) to the OOK sample sequence to generate a frequency domain representation of the OOK sample sequence. In some cases. the transmitter may, using an orthogonal frequency division multiplexing (OFDM) waveform generator, generate an OFDM waveform based on mapping the frequency domain representation of the OOK sample sequence to a set of resource elements of the set of frequency resources. In some cases. the transmitter may transmit the OFDM waveform to the receiver via the set of frequency resources.

### CROSS REFERENCE

The present Application is a 371 national stage filing of International PCT Application No. PCT/CN2022/112982 by Yang et al. entitled “ON-OFF KEYING-MODULATED ORTHOGONAL FREQUENCY DIVISION MULTIPLEXING WAVEFORM GENERATION,” filed Aug. 17, 2022, which is assigned to the assignee hereof, and which is expressly incorporated by reference in its entirety herein.

### FIELD OF TECHNOLOGY

The present disclosure relates to wireless communications, including on-off keying (OOK)-modulated orthogonal frequency division multiplexing (OFDM) waveform generation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, one or more receivers may use amplitude shift keying (ASK), such as on-off keying (OOK), to receive and decode signals. However, some OOK signals used in some wireless communications systems may be incompatible with one or more OFDM signals used in different wireless communications systems.

### SUMMARY

The described techniques relate to improved methods, systems, devices, and apparatuses that support OOK-modulated OFDM waveform generation. For example, the described techniques provide for a transmitter (e.g., a network entity, a base station) to multiplex one or more on-off keying (OOK) waveforms with one or more orthogonal frequency division multiplexing (OFDM) waveforms. In some examples, the transmitter may modulate a set of bits (e.g., having values of 1 or 0) into an OOK sample sequence (e.g., a time domain sample sequence) for wireless transmission to a first receiver (e.g., a UE) in a first set of frequency resources. The transmitter may apply a transform to the OOK sample sequence to generate a frequency domain representation of the OOK sample sequence. For example, the transformed OOK sample sequence may be represented as a time domain frequency domain sample sequence. Using the frequency domain sample sequence, the transmitter may generate the OOK-based OFDM waveform. In some aspects, the frequency domain sample sequence is mapped to one or more resource elements included in the first set of frequency resources. The transmitter may transmit the OFDM waveform to the first receiver. As such, the receiver may use OOK signals to receive and decode the OFDM waveform.

A method for wireless communication at a transmitter is described. The method may include modulating a set of bits into an OOK sample sequence for wireless transmission to a first receiver within a first set of frequency resources, applying a transform to the OOK sample sequence to generate a frequency domain sample sequence that is a frequency domain representation of the OOK sample sequence, generating an OFDM waveform based on mapping the frequency domain sample sequence to a first set of multiple resource elements within the first set of frequency resources, and transmitting the OFDM waveform to the first receiver via the first set of frequency resources.

An apparatus for wireless communication at a transmitter is described. The apparatus may include a processor, memory coupled with the processor, and instructions stored in the memory. The instructions may be executable by the processor to cause the apparatus to modulate a set of bits into an OOK sample sequence for wireless transmission to a first receiver within a first set of frequency resources, apply a transform to the OOK sample sequence to generate a frequency domain sample sequence that is a frequency domain representation of the OOK sample sequence, generate an OFDM waveform based on mapping the frequency domain sample sequence to a first set of multiple resource elements within the first set of frequency resources, and transmit the OFDM waveform to the first receiver via the first set of frequency resources.

Another apparatus for wireless communication at a transmitter is described. The apparatus may include means for modulating a set of bits into an OOK sample sequence for wireless transmission to a first receiver within a first set of frequency resources, means for applying a transform to the OOK sample sequence to generate a frequency domain sample sequence that is a frequency domain representation of the OOK sample sequence, means for generating an OFDM waveform based on mapping the frequency domain sample sequence to a first set of multiple resource elements within the first set of frequency resources, and means for transmitting the OFDM waveform to the first receiver via the first set of frequency resources.

A non-transitory computer-readable medium storing code for wireless communication at a transmitter is described. The code may include instructions executable by a processor to modulate a set of bits into an OOK sample sequence for wireless transmission to a first receiver within a first set of frequency resources, apply a transform to the OOK sample sequence to generate a frequency domain sample sequence that is a frequency domain representation of the OOK sample sequence, generate an OFDM waveform based on mapping the frequency domain sample sequence to a first set of multiple resource elements within the first set of frequency resources, and transmit the OFDM waveform to the first receiver via the first set of frequency resources.

Some examples of the method, apparatuses, and non-transitory computer-readable medium described herein may further include operations, features, means, or instructions for receiving a data sample sequence for transmission to a second receiver within a second set of frequency resources that differs from the first set of frequency resources, applying a second transform to the frequency domain sample sequence and the data sample sequence to generate a time domain representation of a multiplexed signal, and generating the OFDM waveform based on adding a cyclic prefix to the time domain representation of the multiplexed signal.

In some examples of the method, apparatuses, and non-transitory computer-readable medium described herein, generating the OFDM waveform may include operations, features, means, or instructions for generating the OFDM waveform based on inserting a guard band sample in one or more resource elements positioned on either side of the first set of multiple resource elements.

In some examples of the method, apparatuses, and non-transitory computer-readable medium described herein, applying the transform may include operations, features, means, or instructions for applying a discrete Fourier transform (DFT) to the OOK sample sequence to generate the frequency domain sample sequence.

In some examples of the method, apparatuses, and non-transitory computer-readable medium described herein, generating the OFDM waveform may include operations, features, means, or instructions for applying an inverse DFT (IDFT) to the frequency domain sample sequence to generate the OFDM waveform.

In some examples of the method, apparatuses, and non-transitory computer-readable medium described herein, modulating the set of bits into the OOK sample sequence may include operations, features, means, or instructions for identifying an on-duration and an off-duration of the OOK sample sequence based on the set of bits.

In some examples of the method, apparatuses, and non-transitory computer-readable medium described herein, modulating the set of bits into the OOK sample sequence may include operations, features, means, or instructions for modulating an information bit of the set of bits into the OOK sample sequence using Manchester coding.

Some examples of the method, apparatuses, and non-transitory computer-readable medium described herein may further include operations, features, means, or instructions for identifying an on-duration of the OOK sample sequence and an off-duration of the OOK sample sequence, where the on-duration may be shorter than the off-duration.

Some examples of the method, apparatuses, and non-transitory computer-readable medium described herein may further include operations, features, means, or instructions for inserting a first sequence of the one or more samples having the value of zero at an end of the on-duration of the OOK sample sequence, a second sequence of one or more samples having the value of zero at a beginning of the on-duration, or both.

In some examples of the method, apparatuses, and non-transitory computer-readable medium described herein, a length of the first sequence and the second sequence may be based on a cyclic prefix.

In some examples of the method, apparatuses, and non-transitory computer-readable medium described herein, transmitting the OFDM waveform may include operations, features, means, or instructions for transmitting, during a symbol period, the OFDM waveform at a transmission power level that may be based on a length of an on-duration of the OOK sample sequence and a length of an off-duration of the OOK sample sequence.

In some examples of the method, apparatuses, and non-transitory computer-readable medium described herein, the transmission power level may be an average transmission power level that may be normalized according to a target transmission power value based on the length of the on-duration relative to the length of the off-duration.

In some examples of the method, apparatuses, and non-transitory computer-readable medium described herein, the OOK sample sequence corresponds to a first length, and where an on-duration of the OOK sample sequence includes a sequence of samples having a non-zero value of a second length that may be a portion of the first length.

In some examples of the method, apparatuses, and non-transitory computer-readable medium described herein, an off-duration of the OOK sample sequence includes a sequence of samples having a value of zero.

### BRIEF DESCRIPTION OF THE DRAWINGS

FIG. 1 illustrates an example of a wireless communications system that supports on-off keying (OOK)-modulated orthogonal frequency division multiplexing (OFDM) waveform generation in accordance with one or more aspects of the present disclosure.

FIGS. 2 and 3 illustrate examples of waveform generation procedures that support OOK-modulated OFDM waveform generation in accordance with one or more aspects of the present disclosure.

FIG. 4 illustrates an example of waveforms that support OOK-modulated OFDM waveform generation in accordance with one or more aspects of the present disclosure.

FIG. 5 illustrates an example of an OOK signal that supports OOK-modulated OFDM waveform generation in accordance with one or more aspects of the present disclosure.

FIG. 6 illustrates an example of a process flow that supports OOK-modulated OFDM waveform generation in accordance with one or more aspects of the present disclosure.

FIGS. 7 and 8 show block diagrams of devices that support OOK-modulated OFDM waveform generation in accordance with one or more aspects of the present disclosure.

FIG. 9 shows a block diagram of a communications manager that supports OOK-modulated OFDM waveform generation in accordance with one or more aspects of the present disclosure.

FIG. 10 shows a diagram of a system including a device that supports OOK-modulated OFDM waveform generation in accordance with one or more aspects of the present disclosure.

FIGS. 11 through 13 show flowcharts illustrating methods that support OOK-modulated OFDM waveform generation in accordance with one or more aspects of the present disclosure.

### DETAILED DESCRIPTION

Some wireless communications systems (e.g., New Radio (NR)) may include devices that use amplitude shift keying (ASK) such as on-off keying (OOK). In some examples, a receiver (e.g., a network entity, a base station) may use the OOK to receive and decode signals. In some cases, the wireless communications systems may benefit from generating the OOK signals to be compatible with other orthogonal frequency division multiplexing (OFDM) signals. In some aspects, the wireless communications systems may support generating an OOK waveform from an OFDM waveform generator. For example, the OFDM waveform generator may generate an OFDM symbol-based OOK waveform or a sub-OFDM symbol-based waveform. However, some wireless communications systems, such as NR, may not support OFDM-based OOK waveforms. For example, a conventional wireless communications system may not support OFDM-based OOK waveforms because conventional OOK waveforms may interfere with other different signals multiplexed in a frequency domain. Such approaches may result in a bandwidth regrowth problem (e.g., an adjacent channel leakage ratio (ACLR) may be large).

Techniques, systems, and devices described herein support OOK-modulated OFDM waveform generation that may reduce power consumption for a receiver. In some examples, a transmitter may generate an OOK sample sequence, which may be a time domain OOK signal represented by a sequence of bits (e.g., 1s and 0s) of a signal length of M, for transmission to a receiver (e.g., a UE) within a first set of frequency resources. The transmitter may apply a transform (e.g., a discrete Fourier transform (DFT)) to the OOK sample sequence to generate a frequency domain representation of the time domain OOK signal. In some cases, the frequency domain representation may be identified as a frequency domain sample sequence. The transmitter may pass the frequency domain sample sequence to a waveform generator (e.g., an OFDM waveform generator that may apply an inverse DFT (IDFT)), which may generate an OOK-modulated OFDM waveform. In some examples, the waveform generator may generate the OFDM waveform based on mapping the frequency domain sample sequence to a set of resource elements of the first set of frequency resources. As such, the wireless communications system may enable the transmitter to transmit the OFDM waveform to the receiver via the first set of frequency resources.

Aspects of the disclosure are initially described in the context of wireless communications systems. Aspects of the disclosure are then described in the context of waveform generation procedures, waveforms, and process flows. Aspects of the disclosure are further illustrated by and described with reference to apparatus diagrams, system diagrams, and flowcharts that relate to OOK-modulated OFDM waveform generation.

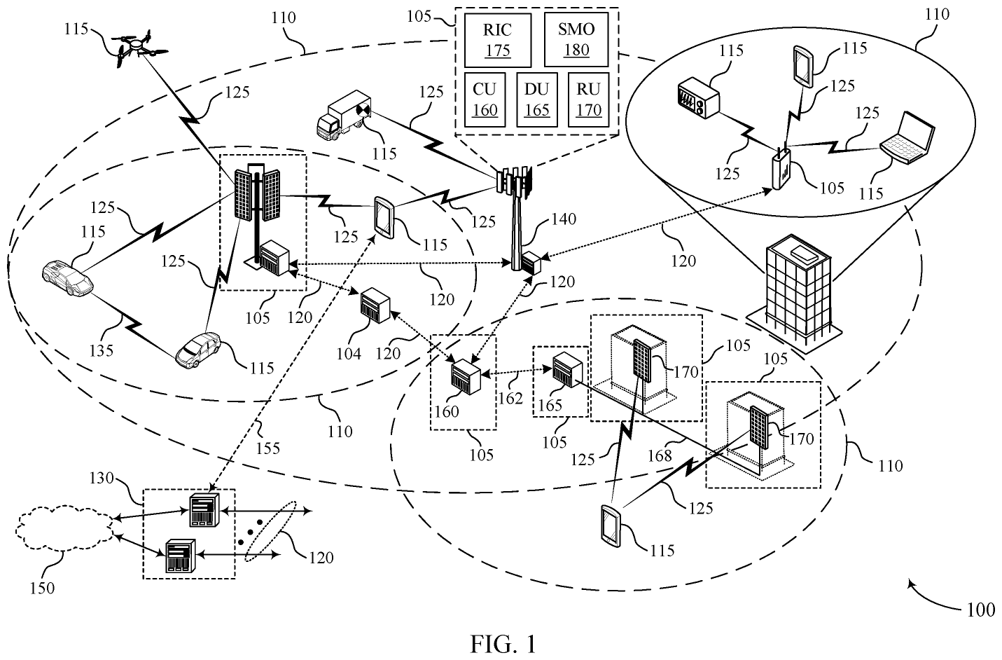

FIG. 1 illustrates an example of a wireless communications system 100 that supports OOK-modulated OFDM waveform generation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support OOK-modulated OFDM waveform generation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting.” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as OFDM or DFT spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported DFT size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communication system 100 may support zero or near-zero-power wireless devices (e.g., receivers, transmitters), as well as other lower power devices. To reduce power consumption of a receiver, the wireless communications system 100 may support ASK-based signals, such as OOK signals. For example, the receiver may use an envelope detector to detect or demodulate OOK signals, which may consume less power than other forms of detection (e.g., coherent detection). In some examples, to further reduce power consumption of a receiver, the receiver may generate OOK signals that are compatible with other OFDM signals. For example, a transmitter (e.g., a network entity, a base station) may generate an OOK waveform for a low-power wakeup signal, which may be received by a low-power receiver. In addition, the transmitter may generate an OFDM-based signal (e.g., a regular OFDM-based signal) which the low-power receiver may receive via main radio components. Additionally, or alternatively, a reference signal (e.g., for time or frequency synchronization) associated with a low-power wakeup signal, which may be referred to as a low-power reference signal, may be based on an OOK waveform such that it may be received by a same low-power receiver.

In some other examples (e.g., in high-frequency or wide-band communications), some devices may use OFDM signals while some other devices may use OOK signals. In such cases, OFDM and OOK signals may be required to coexist in the same wireless spectrum (e.g., a same high-frequency spectrum). As such, the transmitter may multiplex an OOK-based waveform with other OFDM waveforms (e.g., to achieve power savings for the receiver that receives the OOK-based waveform). Additionally, or alternatively, a transmitter (e.g., a network entity, a base station) may transmit both an OOK signal and an OFDM signal, where a first receiver (e.g., a UE) may receive the OOK signal and a second receiver (e.g., a UE) may receive an OFDM signal. Alternatively, in an uplink scenario, the first and second receivers may transmit an OOK signal and an OFDM signal, respectively, however the receiver may receive the OOK and OFDM signals on a same band (e.g., on different resource blocks or resource elements of the same band).

A waveform generator (e.g., an OFDM waveform generator) may generate OFDM waveform that includes an OOK waveform with a particular frequency range. For example, the waveform generator may generate an OFDM symbol-based OOK waveform. In such examples, the transmitter may turn the waveform generator ON and OFF to generate an ON-OFF pattern across multiple OFDM symbols. However, such OFDM symbol-based OOK waveforms may have a relatively high granularity (e.g., being based on one OFDM symbol). In addition, the transmitter may be unable to transmit other non-OFDM waveforms to other receiving devices using the OFDM symbol-based OOK waveforms. Alternatively, the waveform generator may generate sub-OFDM symbol-based waveform. In such examples, the transmitter may zero out half (e.g., a first half or a second half) of an OFDM symbol in a time domain to generate an ON-OFF pattern within an OFDM symbol. However, such sub-OFDM symbol-based waveforms may introduce a bandwidth regrowth problem as the bandwidth of the sub-OFDM symbol may expand after half of the signal being zeroed out. In cases in which the wireless communications system 100 supports Wi-Fi communications, an access point may generate an OOK signal.

In some aspects, the transmitter may use a Manchester code (e.g., a code with phase encoding (PE)) to generate OOK waveforms. For example, Manchester code may include a line code, for which the transmitter may encode each data bit as a high or low state for an equal amount of time (e.g., 0: ON to OFF, 1: OFF to ON). That is, each data bit may be encoded as a transition from an ON state to an OFF state or a transition from an OFF state to an ON state. In some examples, Manchester code may simplify the design of the receiver by enabling a transmitter to refrain from estimating the detector threshold in the receiver and providing a more robust structure against interference (e.g., no bias, equal quantity of 0s and 1s). That is, the transmitter may use a transition between ON and OFF durations to generate the OOK waveforms, where a receiver may detect a change in power instead of detecting an absolute power of the OOK waveforms. However, using Manchester coding with OFDM-symbol based OOK waveforms, the transmitter may transmit one bit for every two OFDM symbols, which may reduce signaling throughput and spectral efficiency.

For NR communications in the wireless communications system 100, a transmitter may multiplex other OFDM signals (e.g., in a frequency domain) with an OOK signal. For example, the wireless communications system 100 may support a transmitter (e.g., a network entity) to multiplex one or more OOK waveforms with one or more OFDM waveforms. In some examples, the transmitter may modulate a set of data bits into an OOK sample sequence, which may be a time domain sample sequence, for wireless transmission to a first receiver in a first set of frequency resources. The transmitter may apply a transform to the OOK sample sequence to be represented as a frequency domain sample sequence (e.g., a frequency representation of the OOK sample sequence). Using the frequency domain sample sequence, the transmitter may generate the OOK-based OFDM waveform. In some aspects, the frequency domain sample sequence is mapped to one or more resource elements included in the first set of frequency resources. The transmitter may transmit the OFDM waveform to the first receiver. As such, the receiver may use simple detection schemes (e.g., non-coherent envelope detection) to decode the OOK-modulated OFDM waveform. It should be noted that the techniques described herein may be applied to ASK-based OFDM waveforms directly, in addition to other OFDM waveforms modulated based on other ASK-based signals.

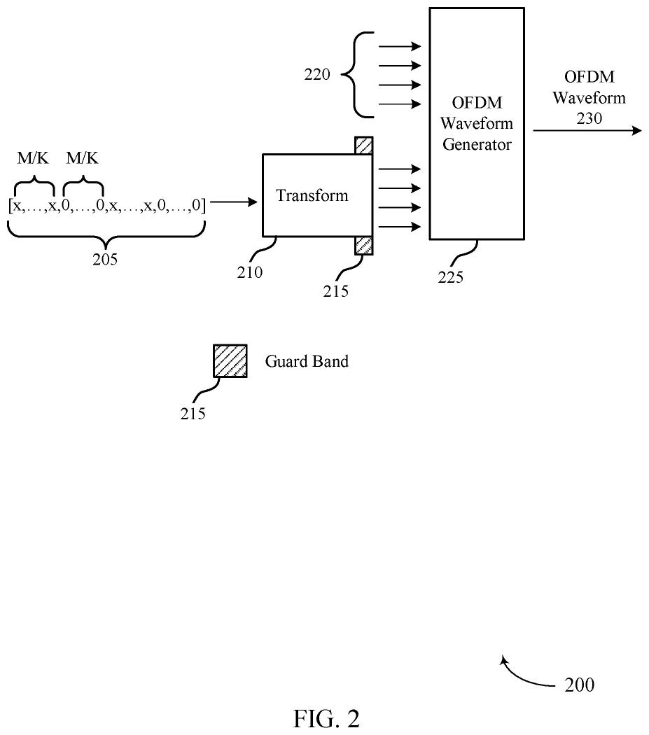

FIG. 2 illustrates an example of a waveform generation procedure 200 that supports OOK-modulated OFDM waveform generation in accordance with one or more aspects of the present disclosure. In some examples, the waveform generation procedure 200 may implement aspects of the wireless communications system 100 or may be implemented by aspects of the wireless communications system 100. For example, a transmitter may use the waveform generation procedure 200 to generate an OFDM waveform 230 (e.g., an OOK-modulated OFDM waveform) for transmission to a receiver. The waveform generation procedure 200 may include a transform 210 and an OFDM waveform generator 225, among other components. In some examples, the transmitter may apply the transform 210 to generate a DFT-spread-OFDM (DFT-S-OFDM)-based intra-symbol OOK signal, which may reduce power consumption at a receiver.

A wireless communications system (e.g., a wireless communications system 100 as described herein) including the waveform generation procedure 200 may support communications between a receiver (e.g., a UE) and a transmitter (e.g., a network entity, a base station). In some examples, a transmitter may modulate a set of bits into an OOK sample sequence 205 of length M (e.g., using BPSK, QPSK, etc.). For example, the OOK sample sequence 205 may include a time domain sample sequence of signals (e.g., comprising bits) where values of bits of the signals may represent an ON duration (e.g., bits of a value of 1) or OFF duration (e.g., bits of a value 0) of the OOK sample sequence 205. That is, the transmitter may identify the ON duration and the OFF duration of the OOK sample sequence 205 based on the set of bits or signals.

In some cases, the transmitter may modulate the set of bits into the OOK sample sequence 205 for wireless transmission to a first receiver within a first set of frequency resources. In some examples, an ON duration of the OOK sample sequence 205 (e.g., x, . . . , x, which may represent a signal of 1 bit) may correspond to a length of M/K samples, where M is an integer multiple of K such that each ON-OFF duration of the OOK sample sequence 205 is a same length. In some examples, K=2^{b}, b=0, 1, 2, . . . , where b=0 may indicate an ON duration of length M. Accordingly, the OOK sample sequence 205 may include a quantity K different ON-OFF levels (e.g., durations).

In some cases, the transmitter may modulate the set of bits into the OOK sample sequence 205 to enable transmission of more than one bits in a same OFDM symbol period. For example, if K=2, the transmitter may generate an ON duration (e.g., a time domain sample sequence XXXX) and an OFF duration (e.g., a time domain sample sequence 0000). The transmitter may concatenate the time domain sample sequences for the ON and OFF durations to modulate the OOK sample sequence 205 (e.g., XXXX0000 or 0000XXXX). Because K=2, the OOK sample sequence 205 may include two bits (e.g., the ON duration may include one bit and the OFF duration may include one bit). As such, the transmitter may transmit the two bits within a same OFDM symbol without using Manchester coding.

In some examples, the OOK sample sequence 205 may use Manchester coding to include a modulated set of bits. For example, the transmitter may modulate an information bit of the set of bits into the OOK sample sequence 205 using Manchester coding. In the example of K=2 and using Manchester coding, the transmitter may modulate the information bit to a time domain sample sequence 00000XXXXX or XXXXX00000 based on whether the information bit has a value of 1 or 0.

In some cases, the ON duration (e.g., an ON state) of the OOK sample sequence 205 may be represented as a non-zero sample sequence (e.g., bits having a value of 1) of length M/K samples. For example, the ON duration may include a binary phase shift keying (BPSK) or π/2 BPSK sequence, a quadrature phase shift keying (QPSK) sequence, a Zadoff-Chu sequence, a vector or sequence having a value of all 1s, a constant-envelope signal (e.g., random BPSK/QPSK signals, which may have the same amplitude for all symbols in a sequence), a pre-defined sequence of symbols, which may be selected such that the OFDM waveform 230 is as close to an ideal OOK signal as possible), or any other low peak-to-average-power ratio (PAPR) sequence. That is, the ON duration of the OOK sample sequence 205 may include a sequence of time domain samples having a non-zero value of a second length (e.g., M/K) that is a portion of a first length of the OOK sample sequence 205 (e.g., M). In some cases, the OFF duration (e.g., an OFF state) of the OOK sample sequence 205 may be represented as a zero sample sequence (e.g., bits having a value of 0).

In some aspects, the transmitter may apply a transform 210 to the OOK sample sequence 205 for wireless transmission to a first receiver within a first set of frequency resources. In some examples, the transform 210 may apply a DFT (e.g., an M-point DFT), which may transform the OOK sample sequence 205 from a time domain sample sequence to a frequency domain sample sequence. In some cases, the frequency domain sample sequence is a frequency domain representation of the OOK sample sequence 205.

In some examples, the transmitter may pass the frequency domain sample sequence into an OFDM waveform generator 225 (e.g., a DFT-S-OFDM waveform generator). The OFDM waveform generator 225 may generate an OFDM waveform 230, which may be an example of a DFT-S-OFDM-based OOK signal, based on mapping the frequency domain sample sequence to a first set of one or more resource elements within the first set of frequency resources. In some examples, the OFDM waveform generator 225 may apply an IDFT (e.g., using an N point IFFT, inverse fast Fourier transform (IFFT), where N>M) to the frequency domain sample sequence to generate the OFDM waveform 230. For example, the OFDM waveform generator 225 may apply the IDFT to the frequency domain sample sequence to map the sample sequence in the frequency domain back into the original time series. For example, the transmitter may apply a DFT-S-OFDM waveform generate that includes an M point DFT and an N point IFFT, where N>M. In this way, the transmitter may generate a DFT-S-OFDM-based intra-symbol OOK signal.

In some cases, to generate an OOK pattern across one or more full OFDM symbols, the transmitter may map all-zero signals (e.g., OFF durations) and all non-zero signals (e.g., ON durations) on frequency-domain subcarriers corresponding to the OOK sample sequence 205. For example, the frequency domain sample sequence may include one or more frequency domain subcarriers that correspond to the OOK pattern (e.g., an ON duration x, . . . , x, an OFF duration 0, . . . , 0). In such cases, the ON duration (e.g., ON state) may be represented by the non-zero sample sequence or signal in a frequency domain that is designed to minimize a PAPR of a generated OFDM waveform (e.g., a dedicated sequence that reduces or minimizes the PAPR of the ON signal). Alternatively, the OFF duration (e.g., OFF state) may be represented by a zero sample sequence or signal in a frequency domain. In some cases, cyclic prefixes may be added to the zero or the non-zero sample sequence. For example, a percentage of samples (e.g., the last X % of samples) in an OFDM symbol are copied and concatenated to the beginning of the OFDM symbol. In some examples, a transmitter may use a single IFFT to generate a signal (e.g., an OFDM waveform) that includes data for both the OOK receiver and a non-OOK receiver.

In some examples, a guard band 215 may be inserted in the frequency domain around a set of subcarriers (e.g., the first set of resource elements within the first set of frequency resources) in which the frequency domain sample sequence (e.g., the frequency representation of the OOK sample sequence 205) is allocated. For example, the transmitter may insert the guard band 215 (e.g., a guard band sample) in one or more resource elements positioned on either side (e.g., before and after or above and below) of the first set of multiple resource elements before the frequency domain sample sequence is passed to the OFDM waveform generator 225. In some cases, the guard band 215 may be inserted to reduce interference for a low-power receiver (e.g., a receiver of the OFDM waveform 230). In such cases, the guard band 215 may ensure that other signals (e.g., signals other than the frequency domain sample sequence of the OOK sample sequence 205) refrain from creating interference for the low-power receiver (which may use a relatively course filter when decoding transmissions) by keeping the other signals separated from the frequency domain sample sequence. For example, the guard band 215 may correspond to a subset of specific subcarriers at either end of the first set of frequency resources. Accordingly, the transmitter may use the first set of resource elements within the first set of frequency resources for the frequency domain sample sequence, which may be guarded from interference by the subset of subcarriers on either end of the frequency domain sample sequence allocated for the guard band 215.

In some examples, the transmitter may receive other data for transmission to additional receivers (other than the first receiver). In some cases, the other data may include a data sample sequence 220 (e.g., non-OOK based signals), which may be multiplexed with the frequency domain sample sequence (e.g., the frequency representation of the OOK sample sequence 205) in the frequency domain. The transmitter may apply a second transform (e.g., an IDFT) to the frequency domain sample sequence and the data sample sequence to generate a time domain representation of a multiplexed signal.

Based on the data sample sequence 220, the OFDM waveform generator 225 may generate the OFDM waveform 230 based on adding a cyclic prefix to the time domain representation of the multiplexed signal. As such, the OFDM waveform generator 225 may generate the OFDM waveform 230 based on the frequency domain representation of the OOK sample sequence 205 and the data sample sequence 220, where each sample sequence may be allocated to a different set of resources (e.g., frequency domain resources). In some examples, the OFDM waveform generator 225 may transmit the OFDM waveform 230 to the first receiver via the first set of frequency resources.

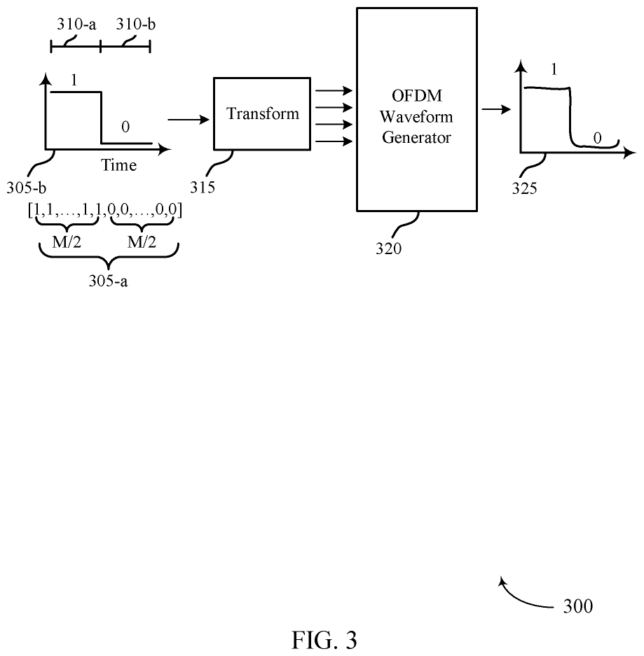

FIG. 3 illustrates an example of a waveform generation procedure 300 that supports OOK-modulated OFDM waveform generation in accordance with one or more aspects of the present disclosure. The waveform generation procedure 300 may be implemented by aspects of the wireless communications system 100. For example, the waveform generation procedure 300 may be implemented by a transmitter, a receiver, or any combination thereof, as described with reference to FIGS. 1 and 2. In some examples, a transmitter may use the waveform generation procedure 300 to generate an example of an OOK-modulated OFDM waveform (e.g., the OFDM waveform 230 described herein with reference to FIG. 2).

In some examples, a transmitter (e.g., a network entity or UE) may modulate a set of bits into an OOK sample sequence using Manchester coding. For example, the transmitter may transmit one bit of Manchester code for each OFDM symbol allocated for transmission of an OFDM waveform 325 (e.g., an OOK-modulated OFDM waveform). The transmitter may implement a Manchester code that uses repetition for modulating the set of bits into an OOK sample sequence 305-a of length M. In some examples, the OOK sample sequence 305-a may include zeros and ones that represent a waveform 305-b. That is, the waveform 305-b may represent the Manchester code of each information bit in the OOK sample sequence 305-a.

In some aspects, the transmitter may modulate the OOK sample sequence 305-a based on a length M=144 subcarriers, K=2, and a subcarrier spacing of 30 KHz. That is, the OOK sample sequence 305-a may include the set of bits with a length M (e.g., M subcarriers), where an ON duration or an OFF duration of the OOK sample sequence 305-a each have a length of M divided by 2 (e.g., M/K). For example, the OOK sample sequence 305-a may include two samples (e.g., K=2), where a first half of the OOK sample sequence 305-a may be represented as a non-zero sample sequence (e.g., bits having a value of 1) of length M/2 samples. Additionally, a second half of the OOK sample sequence 305-a may be represented as a zero sample sequence (e.g., the bits having a value of 0) of length M/2 samples.

Additionally, the waveform 305-b may represent the OOK sample sequence 305-a as a square wave with a peak value of 1 (e.g., representing bits of the OOK sample sequence 305-a having a value of 1) and a low value of 0) (e.g., bits of the OOK sample sequence 305-a having a value of 0). Accordingly, half of the waveform 305-b may represent the ON duration of the OOK sample sequence 305-a and the other half of the waveform 305-b may represent the OFF duration of the OOK sample sequence 305-a, where each half of the sequence may have a length of M divided by K samples. As such, the ON duration may correspond to a non-zero time domain sample sequence 310-a and the OFF duration may correspond to a zero time domain sample sequence 310-b, where the non-zero time domain sample sequence has a length equivalent to the length of the zero time domain sample sequence 310-b (e.g., M/2 samples).

In some cases, the transmitter may apply a transform 315 to the OOK sample sequence 305-a for wireless transmission to a first receiver (e.g., a first UE) within a first set of frequency resources. In some examples, the transform 315 may be a DFT (e.g., an M point DFT), which may transform the OOK sample sequence 305-a from a time domain sample sequence to a frequency domain sample sequence. In some cases, the frequency domain sample sequence is a frequency domain representation of the OOK sample sequence 305-a.

In some examples, the transmitter may pass the frequency domain sample sequence into an OFDM waveform generator 320. The OFDM waveform generator 320 may generate the OFDM waveform 325 based on mapping the frequency domain sample sequence to a first set of multiple resource elements. In some cases, the first set of multiple resource elements may be included in the first set of frequency resources. In some examples, the OFDM waveform generator 320 may apply an IDFT (e.g., an N point IFFT, IFFT, where N>M) to the frequency domain sample sequence.

In some cases, the OFDM waveform generator 320 may transmit the OFDM waveform 325 (e.g., an OOK-modulated OFDM waveform) to the first receiver. In some examples, the OFDM waveform 325 may correspond to the waveform 305-b, which represents the OOK sample sequence 305-a. In some aspects, the OFDM waveform 325 may represent an example of the frequency domain sample sequence when passed through a low pass filter (LPF) and a 4 MHz subsampling of the frequency domain sample sequence. In some examples, the first receiver may receive the OFDM waveform 325 from the transmitter via the first set of frequency resources. In some examples, because the frequency domain sample sequence is mapped to specific resource elements of the first set of frequency resources, the bandwidth for transmitting the OFDM waveform 325 is limited to the resource elements (e.g., a set of subcarriers). Using the techniques described herein, the OFDM waveform 325 may refrain from leaking (e.g., causing interference) to other tones (e.g., bands) or subcarriers outside of the bandwidth allocated for the OFDM waveform 325, as the OFDM waveform 325 may be limited to the M subcarriers in which the frequency domain sample sequence (e.g., the frequency representation of the OOK sample sequence 305) are allocated. As such, the OOK sample sequence 305 may be transmitted in the OFDM waveform 325 while refraining from detrimentally interfering with data transmitted in other frequencies of the OFDM waveform 325.

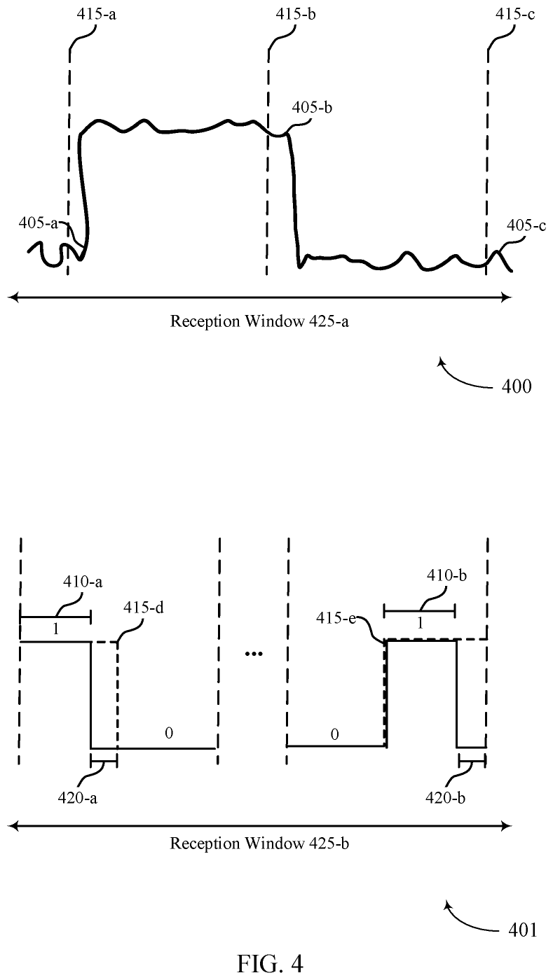

FIG. 4 illustrates an example of a waveform 400 and a waveform 401 that supports OOK-modulated OFDM waveform generation in accordance with one or more aspects of the present disclosure. In some examples, the waveform 400 and the waveform 401 may be implemented by aspects of the wireless communications system 100. For example, a transmitter may generate an OOK modulated OFDM waveform for a transmission to a receiver based on an OOK sample sequence, which may be an example of the waveform 400 and the waveform 401.

In some examples, inserting one or more CPs may provide a more robust structure to the waveform 400, which may reduce delay spread and timing errors. In some examples, the cyclic prefix insertion may lead to inter-symbol interference (ISI) issues, where signals of the same frequency may interfere. In some cases, a receiver (e.g., a UE) may be unaware of the delay spread of the frequency channel and cause ISI issues. In some OFDM systems, the receiver may estimate the delay spread from pilot transmissions (e.g., demodulation reference signals (DMRSs)) to compensate for the delay spread. Alternatively, in some systems where the transmitter transmits OOK signals and the receiver uses an envelope detector to decode such OOK signals, the receiver may be unable to estimate the delay spread. As such, the energy in a ON duration of the OOK signal may leak into an OFF duration, resulting in reduced signal energy from the ON duration and increased interference or energy level in the OFF duration, and thus, decreased system performance.

A receiver may receive the waveform 400 during a reception window 425-a. The waveform 400 may include one or more ON-OFF durations between boundaries 415. For example, an ON duration may occur between a boundary 415-a and a boundary 415-b, and an OFF duration may occur between the boundary 415-a and a boundary 415-c. If the waveform 400 is an OOK sample sequence, and using Manchester coding, the receiver may detect a transition from an OFF duration to an ON duration (e.g., at the boundary 415-a and the boundary 415-c) or an ON duration to an OFF duration (e.g., at the boundary 415-b). Based on identifying the transition, the receiver determine whether the waveform 400 includes a bit of a value of 0 or 1 at a given time during the reception window 425.

In order for the receiver to accurately detect such transitions in this way, the receiver may have some indication of where an ON-OFF transition may occur. That is, the receiver may rely on knowing a center of an OFDM symbol in which the waveform 400 is transmitted, the center representing the transition between the ON and OFF durations of the waveform 400. However, the receiver may lack knowledge of a delay spread associated with the waveform 400 as described herein, and as such, the receiver may be unable to accurately detect the transition point. For example, at the boundary 415-a, the waveform 400 may be expected to transition from an OFF duration to an ON duration. Due to the delay spread, however, the ON duration may begin some time after the boundary 415-a, and as such, there may be an energy leakage 405-a where the ON duration loses energy. In addition, the waveform 400 may be expected to transition from the ON duration to the OFF duration at the boundary 415-b. However, the delay spread may result in an energy leakage 405-b from the ON duration to the OFF duration (e.g., energy may leak from the ON duration into the OFF duration), such that a power level for the ON duration and a quality of the waveform 400 may be decreased. This reduced energy for the ON duration may repeat for an energy leakage 405-c, which may be based on the transition from the OFF duration to a second ON duration being delayed.

To prevent such energy leakage, as described herein, a transmitter may insert one or more samples with a value of zero to a waveform 401 (e.g., an OOK sample sequence) for transmission of the waveform 401 during a reception window 425-b. For example, the transmitter may identify an ON duration and an OFF duration of an OOK sample sequence (e.g., the waveform 401), where the ON duration is shorter than the OFF duration. Then, the transmitter may insert one or more zero-samples (e.g., samples having a value of zero) associated with an ON duration of the waveform 401 associated with a cyclic prefix. In some cases, a length of a sequence of zero-samples may be based on a cyclic prefix. As such, inserting the one or more zero-samples may reduce the energy leakage between ON-OFF durations of the waveform 401 based on leveling an energy to a peak or low level prior to the waveform 401 transitioning to an ON duration or an OFF duration.

In some examples, the transmitter may insert the zero-samples at an end of each ON duration of the waveform 401 prior to applying a transform (e.g., a DFT) to the waveform 401 as described herein (e.g., a pre-DFT zero-sample insertion). In some cases, the inserted zero-samples may be associated with a cyclic prefix, where a length of the inserted zero-samples may be equal to or larger than a cyclic prefix duration (e.g., a percentage of a quantity of subcarriers or samples occupied by the waveform 401, X %*M zero-samples). For example, the waveform 401 may include a shortened ON duration 410-a (e.g., corresponding to a bit with a value of 1) followed by an insertion of a sequence of zero-samples 420-a before a boundary 415-d. The length of the sequence of zero-samples 420-a may be equal to or larger than the cyclic prefix duration. The boundary 415-d may represent a half-symbol boundary, or a time at which an ON duration of a OOK sample sequence may transition to an OFF duration. As such, by inserting the sequence of zero-samples after the shortened ON duration 410-a, the transmitter may effectively cause the shortened ON duration 410-a to transition to the OFF duration at the boundary 415-d. Additionally, if the waveform 401 is modulated using Manchester coding, the half symbol boundary 415-d may follow the Manchester coding and effectively split the OOK sample sequence into two portions, where a length of the sum of the shortened ON duration 410-a and the sequence of zero-samples 420-a is equivalent to a length of the OFF duration.

Another portion of the waveform 401 may demonstrate a shortened ON duration 410-b followed by the insertion of a sequence of zero-samples 420-b to length the ON duration of the waveform 401 after a boundary 415-e. In some cases, the sequence of zero-samples 420-b may have a length equal to or larger than a cyclic prefix duration. The boundary 415-e may represent a half-symbol boundary, or a time at which an OFF duration of a OOK sample sequence may transition to an ON duration. As such, by inserting the sequence of zero-samples after the shortened ON duration 410-b, the transmitter may prevent energy leakage from the ON duration. Additionally, if the waveform 401 is modulated using Manchester coding, the half symbol boundary 415-e may follow the Manchester coding and effectively split the OOK sample sequence into two portions, where a length of the shortened ON duration 410-b and the sequence of zero-samples 420-b is equivalent to a length of the preceding OFF duration.

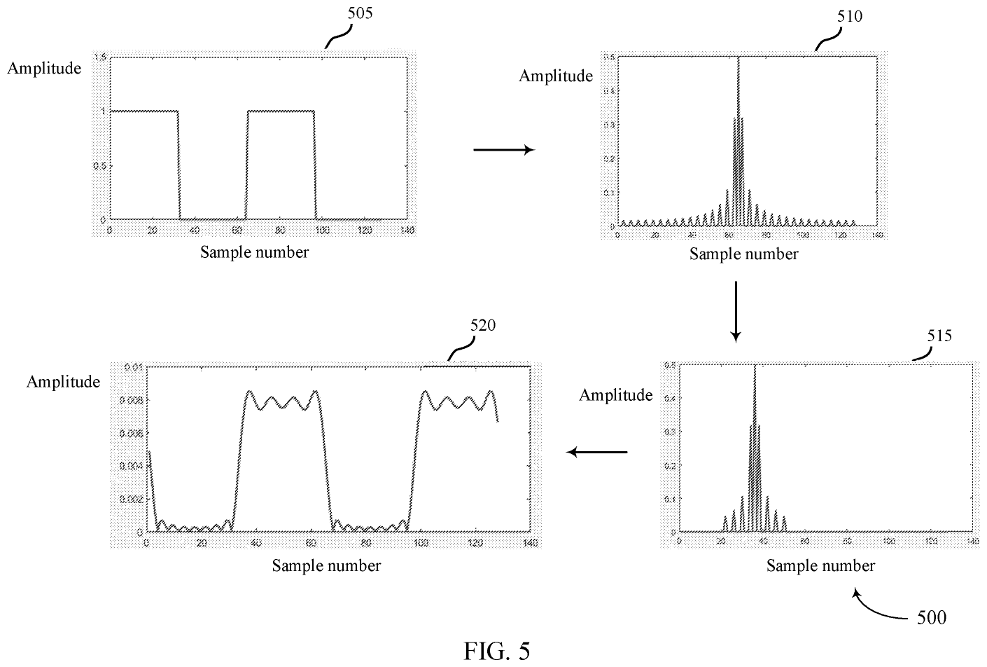

In some examples, the transmitter may generate the waveform 401 such that the waveform 401 is a bandwidth-limited OOK signal with shortened ON durations 410. For example, as for an OOK signal with typical ON durations as described herein with reference to FIG. 5, the transmitter may convert an original time domain OOK signal (e.g., an ideal time domain sample sequence) with a shortened ON duration to the frequency domain (e.g., using a DFT, FFT) to obtain a frequency domain OOK signal with a shortened ON duration. The transmitter may shift a center of the frequency domain OOK signal to a center of a set of resources allocated for the waveform 401 and zero out any frequency domain signals that fall outside of the set of allocated resources. In some examples, the transmitter may convert the frequency domain OOK signal back to the time domain (e.g., using an IDFT, an IFFT), where the time domain OOK signal may represent a bandwidth-limited OOK signal.

Additionally, or alternatively, a sequence of zero-samples 420 may be inserted before an ON duration of the OOK sample sequence. That is, the transmitter may insert a first sequence of zero-samples at an end of a shortened ON duration 410 and a second sequence of zero-samples at a beginning of the shortened ON duration 410, or both. Put another way, the transmitter may insert some sequence of zero-samples 420 in a beginning portion of a shortened ON duration 410 such that half of some quantity of Z zero-samples are inserted before and after the shortened ON duration 410 (e.g., Z/2% zero-samples inserted at the beginning of the shortened ON duration 410, Z/2% zero-samples inserted at the end of the shortened ON duration 410).

In some examples, the transmitter may insert a sequence of zero-samples 420 associated with a cyclic prefix in different ways. For example, the transmitter may insert a cyclic prefix to the waveform 401 by copying an ending Y % of a of a time domain OOK sample sequence (e.g., a post-IDFT or post-IFFT OFDM signal) to the beginning of the OOK sample sequence. In cases in which the OOK sample sequence is FDMed with other regular OFDM signals, the receiver may insert a cyclic prefix before or after a time domain sample sequence (e.g., the post-IDFT or post-IFFT OFDM signal) of the multiplexed signal. For example, the ON duration of an OOK sample sequence may include bits with a value of zero added to the beginning of a symbol period of the frequency domain sample sequence (e.g., a symbol period may read 0,0,1,1,1,1,0,0). The transmitter may use an IDFT to return the frequency domain sample sequence to a time domain representation and generate the OFDM waveform for both OOK-based signals and non-OOK based signals. In this way, when an OOK signal is multiplexed with other non-OOK signals (e.g., regular OFDM signals), the transmitter may first generate the multiplexed OOK and OFDM signal (e.g., by the OFDM waveform generator 225 as described herein with reference to FIG. 2), and then add a cyclic prefix jointly to the multiplexed signal. Using this approach, the transmitter may perform cyclic prefix insertion for an OOK-modulated OFDM waveform as for a regular OFDM waveform.

In some examples, a transmitter may transform the waveform 401 (e.g., including one or more shortened ON durations 410, one or more sequences of zero-samples 420, and one or more OFF durations) into a frequency domain representation of an OOK sample sequence, such as the frequency domain sample sequence. The transmitter may then pass the waveform 401 to an OFDM waveform generator, which may generate an OOK-modulated OFDM waveform for transmission to a receiver during a symbol period and using a transmission power. In some cases, a transmission power level may be normalized so that a total energy remains the same during an ON duration (e.g., similar to cases in which the sequences of zero-samples 420 are not implemented. In some examples, the transmission power may be based on the lengths of the ON-OFF durations for the OOK sample sequence. For example, the transmitter may transmit, during a symbol period, the OFDM waveform at a transmission power level that is based on a length of the ON duration of the waveform 401 and a length of the OFF duration of the waveform 401. In some aspects, the transmission power level may be an average transmission power level that may be normalized with a target transmission power value based on the length of the ON duration relative to the length of the OFF duration.

FIG. 5 illustrates an example of an OOK signal 500 that supports OOK-modulated OFDM waveform generation in accordance with one or more aspects of the present disclosure. In some examples, the OOK signal 500 may be an OOK-based OFDM waveform that is generated to represent an ideal OOK signal. For example, a transmitter may use an OFDM waveform generator (e.g., such as the OFDM waveform generator 225 described herein with reference to FIG. 2) to generate the OOK signal 500, which may have a limited bandwidth.

In some examples, the transmitter may generate an OOK sample sequence (e.g., a time-domain OOK signal having ON and OFF durations of equal length) with a restricted (e.g., limited) bandwidth. That is, while the transmitter may generate the OOK sample sequence to resemble an OOK signal (e.g., an ideal OOK signal), the transmitter may restrict the bandwidth of the OOK sample sequence instead of using an unlimited bandwidth characteristic of an OOK signal.

In some examples, an OOK signal 505 may correspond to a step function or square wave function (e.g., an ideal step function) that includes abrupt transitions from one value to another (e.g., from a high value to a low value, a low value to a high value). For example, time domain OOK samples of the OOK signal 505 may have a length equal to an IFFT size (e.g., an IDFT size) applied to the OOK signal 505 (e.g., the IDFT applied to the frequency domain sample sequence by the OFDM waveform generator 225 as described herein with reference to FIG. 2). For example, the time domain OOK samples may correspond to a length N instead of a length M, where M may represent a size of an allocated bandwidth, and N may represent a size of a DFT or an FFT applied to the time domain OOK samples.

In some cases, the transmitter may apply a transform to the OOK signal 505 to convert it from a time domain OOK sequence to a frequency domain signal 510. The transform may include a DFT or an FFT. Based on the transform, the frequency domain signal 510 may have a length N, which may include a first set of frequency resources (e.g., resource elements, resource blocks) allocated for the OOK signal 505 and other signals (e.g., regular data for other users). In this way, the transmitter may generate a third frequency domain sample sequence that comprises the frequency domain sample sequence as described herein with reference to FIG. 2. That is, the transmitter may transform the OOK signal 505 from the time domain to the frequency domain. In terms of the OOK signal, the frequency domain signal 510 (which has an unlimited bandwidth) may correspond to an impulse signal with sidelobe ripples that extend across all frequencies above and below the impulse.

Then, the transmitter may shift a center of the frequency domain signal 510 (e.g., a transition point between ON and OFF durations of an OOK sample sequence) to a center of an allocated bandwidth and zero out signal components outside of the allocated bandwidth, to generate a shifted frequency domain signal 515. That is, the transmitter may shift a center of the frequency domain signal 510 to align with a center of the first set of multiple resource elements and remove one or more samples of the third frequency domain signal 510 that occur outside of the set plurality of resource elements after the shifting to generate the shifted frequency domain signal 515. After the frequency domain signals have been zeroed-out outside of the allocated bandwidth (e.g., the first set of resource elements), the shifted frequency domain signal 515 that is remaining may only include M non-zero values in frequency, where M may represent the side of the allocated bandwidth (e.g., a quantity of allocated resource elements). In this way, the transmitter may effectively limit the bandwidth of the OOK signal 505 by centering an OOK sample sequence in a first set of resource elements corresponding to the first set of frequency resources, and limiting any signaling outside of the allocated bandwidth. At this point, due to the shifting, the impulse of the OOK signal 505 (e.g., the original OOK signal) may be shifted, and any sidelobe ripples outside of the allocated bandwidth may be removed.

The transmitter may convert the shifted frequency domain signal 515 back into the time domain such that an OFDM waveform generator may generate an OFDM waveform 520, which now may be bandwidth-limited. When converted back to a time domain signal, the OFDM waveform 520 may be represented as a wavy, step-like function that lacks as sharp of transitions as in a pure (e.g., ideal) step function, and that is contained within the allocated bandwidth (e.g., as the bandwidth-limited waveform).

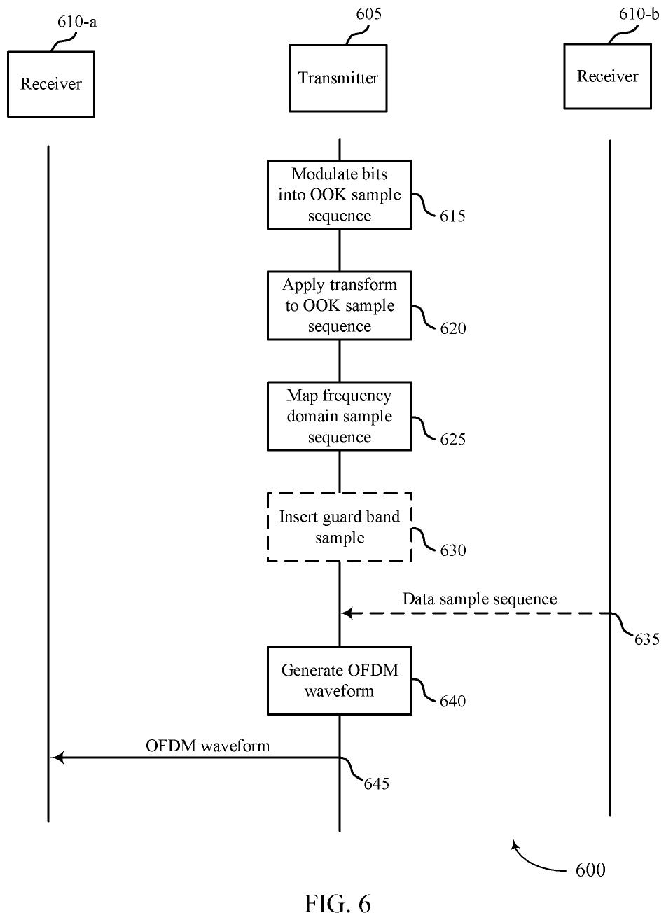

FIG. 6 illustrates an example of a process flow 600 that supports OOK-modulated OFDM waveform generation in accordance with one or more aspects of the present disclosure. In some examples, the process flow 600 may implement or be implemented by aspects of the wireless communications systems 100 and the waveform generation procedures 200 and 300 as described with reference to FIGS. 1-3. For example, the process flow 600 illustrates communications between a transmitter 605, a receiver 610-a (e.g., a first receiver), and a receiver 610-b (e.g., a second receiver), which may represent examples of corresponding devices described with reference to FIGS. 1-3. For example, the transmitter 605 may be a network entity or a UE, and the receivers 610 may be network entities or UEs. In some aspects, the transmitter 605 may support OOK-based OFDM waveform generation for transmission to the receiver 610-a or the receiver 610-b. In the following description of the process flow 600, the operations between the transmitter 605 and the receivers 610 may be performed in different orders or at different times. Some operations may also be left out of the process flow 600, or other operations may be added. Although the transmitter 605 and the receivers 610 are shown performing the operations of the process flow 600, some aspects of some operations may also be performed by one or more other wireless devices.

At 615, the transmitter 605 may modulate a set of bits into an OOK sample sequence for wireless transmission to a first receiver within a first set of frequency resources. In some examples, the OOK sample sequence may include a time domain sample sequence of bits (e.g., 0s and 1s), where values of the bits may represent an ON duration (e.g., bits having a value of 1) or an OFF duration (e.g., bits having a value of 0). Additionally, or alternatively, the transmitter 605 may modulate an information bit of the set of bits in the OOK sample sequence using a Manchester coding method.

At 620, the transmitter may apply a transform to the OOK sample sequence to generate a frequency domain sample sequence that is a frequency domain representation of the OOK sample sequence. In some cases, the transform may include a DFT.

At 625, the transmitter 605 may map the frequency domain sample sequence to a first set of multiple resource elements in the first set of frequency resources. For example, the transmitter 605 may map the frequency domain sample sequence to one or more subcarriers of the first set of frequency resources, which may be allocated for transmission to the receiver 610-a.

At 630, the transmitter 605 may insert a guard band sample in one or more resource elements positioned on either side of a set of multiple resource elements if the first set of frequency resources. In some instances, the guard band may span one or more subcarriers of the first set of frequency resources. That is, the guard band sample may be inserted before and after the frequency domain sample sequence. In some examples, the OFDM waveform generator may use the guard band sample to generate the OFDM waveform.

At 635, the transmitter 605 may receive a data sample sequence for transmission to the receiver 610-b within a second set of frequency resources that differs from the first set of frequency resources. The data sample sequence may include regular OFDM signals or other data that may be multiplexed with an OFDM waveform.

At 640, the transmitter 605 may generate the OFDM waveform based on mapping the frequency domain sample sequence to the set of multiple resource elements in the first set of frequency resources. In some examples, an OFDM waveform generator may apply an IDFT (e.g., or an IFFT) to the frequency domain sample sequence to generate the OFDM waveform (e.g., by transforming the OOK sample sequence back to the time domain from the frequency domain). Additionally, or alternatively, the transmitter 605 may apply a second transform, such as an IFFT, to the frequency domain sample sequence and the data sample sequence to generate a time domain representation of a multiplexed signal. As such, the OFDM waveform generator may generate the OFDM waveform based on adding a cyclic prefix to the time domain representation of the multiplex signal to generate the OFDM waveform. In some examples, the OFDM waveform generator may additionally add a cyclic prefix by copying an end portion of the IFFT output and repeating the end portion at the beginning of the generated OFDM waveform. Additionally, or alternatively, the transmitter 605 may generate the OFDM waveform based on inserting the guard band sample.

At 645, the transmitter 605 may transmit the OFDM waveform to the receiver 610-a via the first set of frequency resources. In some implementations, the transmitter 605 may transmit the OFDM waveform using a transmission power level based on lengths of ON-OFF durations of the OOK sample sequence. Alternatively, the transmission power level may be normalized with a target transmission power value.

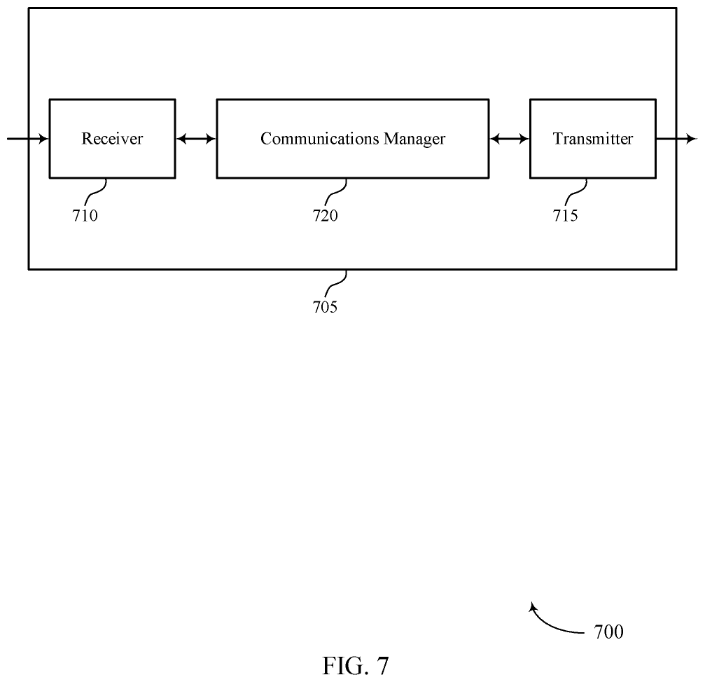

FIG. 7 shows a block diagram 700 of a device 705 that supports OOK-modulated OFDM waveform generation in accordance with one or more aspects of the present disclosure. The device 705 may be an example of aspects of a transmitter as described herein. The device 705 may include a receiver 710, a transmitter 715, and a communications manager 720. The device 705 may also include one or more processors, memory coupled with the one or more processors, and instructions stored in the memory that are executable by the one or more processors to enable the one or more processors to perform the OFDM generation features discussed herein. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations thereof or various components thereof may be examples of means for performing various aspects of OOK-modulated OFDM waveform generation as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a transmitter in accordance with examples as disclosed herein. For example, the communications manager 720 may be configured as or otherwise support a means for modulating a set of bits into an OOK sample sequence for wireless transmission to a first receiver within a first set of frequency resources. The communications manager 720 may be configured as or otherwise support a means for applying a transform to the OOK sample sequence to generate a frequency domain sample sequence that is a frequency domain representation of the OOK sample sequence. The communications manager 720 may be configured as or otherwise support a means for generating an OFDM waveform based on mapping the frequency domain sample sequence to a first set of multiple resource elements within the first set of frequency resources. The communications manager 720 may be configured as or otherwise support a means for transmitting the OFDM waveform to the first receiver via the first set of frequency resources.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for OOK-modulated OFDM waveform generation, which may reduce power consumption, minimize a PAPR of an OFDM signal, and increase spectral efficiency.

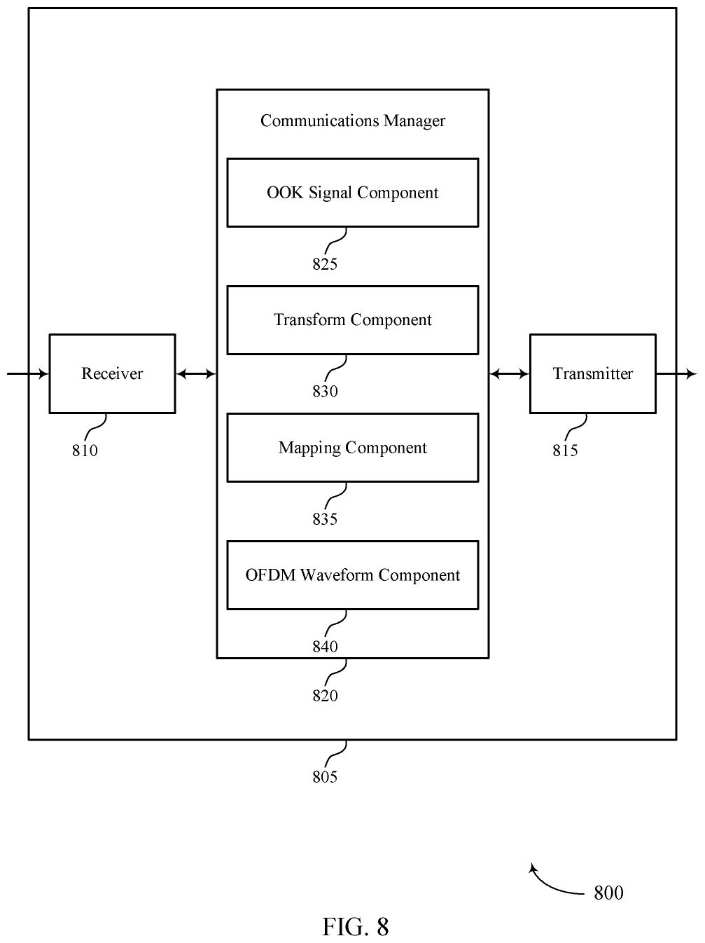

FIG. 8 shows a block diagram 800 of a device 805 that supports OOK-modulated OFDM waveform generation in accordance with one or more aspects of the present disclosure. The device 805 may be an example of aspects of a device 705 or a transmitter (e.g., a UE 115) as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of OOK-modulated OFDM waveform generation as described herein. For example, the communications manager 820 may include a OOK signal component 825, a transform component 830, a mapping component 835, an OFDM waveform component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a transmitter in accordance with examples as disclosed herein. The OOK signal component 825 may be configured as or otherwise support a means for modulating a set of bits into an OOK sample sequence for wireless transmission to a first receiver within a first set of frequency resources. The transform component 830 may be configured as or otherwise support a means for applying a transform to the OOK sample sequence to generate a frequency domain sample sequence that is a frequency domain representation of the OOK sample sequence. The mapping component 835 may be configured as or otherwise support a means for generating an OFDM waveform based on mapping the frequency domain sample sequence to a first set of multiple resource elements within the first set of frequency resources. The OFDM waveform component 840 may be configured as or otherwise support a means for transmitting the OFDM waveform to the first receiver via the first set of frequency resources.

In some cases, the OOK signal component 825, the transform component 830, the mapping component 835, and the OFDM waveform component 840 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the OOK signal component 825, the transform component 830, the mapping component 835, and the OFDM waveform component 840 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

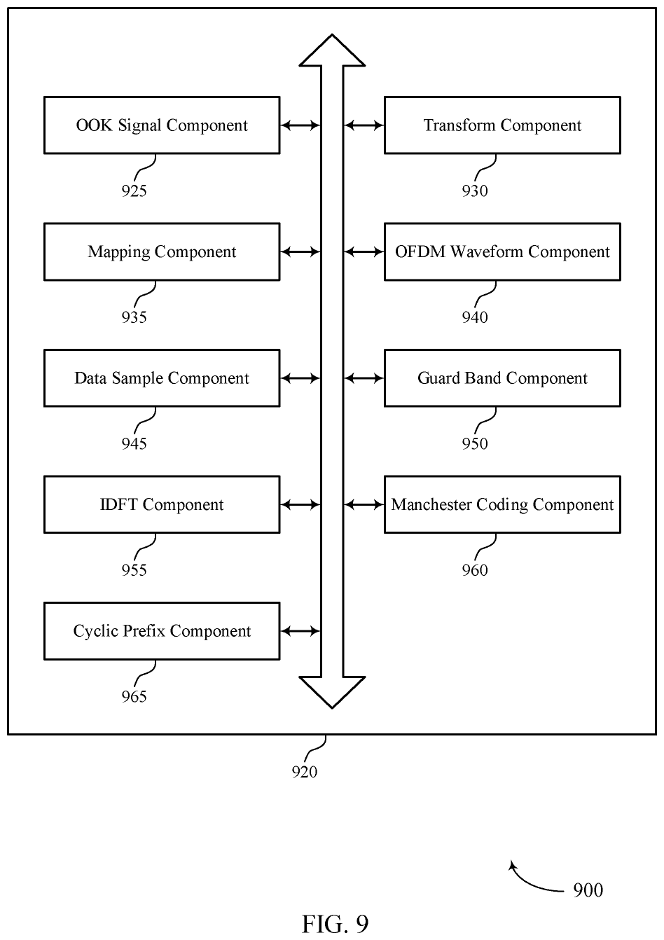

FIG. 9 shows a block diagram 900 of a communications manager 920 that supports OOK-modulated OFDM waveform generation in accordance with one or more aspects of the present disclosure. The communications manager 920 may be an example of aspects of a communications manager 720, a communications manager 820, or both, as described herein. The communications manager 920, or various components thereof, may be an example of means for performing various aspects of OOK-modulated OFDM waveform generation as described herein. For example, the communications manager 920 may include a OOK signal component 925, a transform component 930, a mapping component 935, an OFDM waveform component 940, a data sample component 945, a guard band component 950, an IDFT component 955, a Manchester coding component 960, a cyclic prefix component 965, or any combination thereof. Each of these components may communicate, directly or indirectly, with one another (e.g., via one or more buses).

The communications manager 920 may support wireless communication at a transmitter in accordance with examples as disclosed herein. The OOK signal component 925 may be configured as or otherwise support a means for modulating a set of bits into an OOK sample sequence for wireless transmission to a first receiver within a first set of frequency resources. The transform component 930 may be configured as or otherwise support a means for applying a transform to the OOK sample sequence to generate a frequency domain sample sequence that is a frequency domain representation of the OOK sample sequence. The mapping component 935 may be configured as or otherwise support a means for generating an OFDM waveform based on mapping the frequency domain sample sequence to a first set of multiple resource elements within the first set of frequency resources. The OFDM waveform component 940 may be configured as or otherwise support a means for transmitting the OFDM waveform to the first receiver via the first set of frequency resources.

In some examples, the data sample component 945 may be configured as or otherwise support a means for receiving a data sample sequence for transmission to a second receiver within a second set of frequency resources that differs from the first set of frequency resources. In some examples, the transform component 930 may be configured as or otherwise support a means for applying a second transform to the frequency domain sample sequence and the data sample sequence to generate a time domain representation of a multiplexed signal. In some examples, the mapping component 935 may be configured as or otherwise support a means for generating the OFDM waveform based on adding a cyclic prefix to the time domain representation of the multiplexed signal.

In some examples, to support generating the OFDM waveform, the guard band component 950 may be configured as or otherwise support a means for generating the OFDM waveform based on inserting a guard band sample in one or more resource elements positioned on either side of the first set of multiple resource elements.

In some examples, to support applying the transform, the transform component 930 may be configured as or otherwise support a means for applying a DFT to the OOK sample sequence to generate the frequency domain sample sequence.

In some examples, to support generating the OFDM waveform, the IDFT component 955 may be configured as or otherwise support a means for applying an IDFT to the frequency domain sample sequence to generate the OFDM waveform.

In some examples, to support modulating the set of bits into the OOK sample sequence, the OOK signal component 925 may be configured as or otherwise support a means for identifying an on-duration and an off-duration of the OOK sample sequence based on the set of bits.

In some examples, to support modulating the set of bits into the OOK sample sequence, the Manchester coding component 960 may be configured as or otherwise support a means for modulating an information bit of the set of bits into the OOK sample sequence using Manchester coding.

In some examples, the cyclic prefix component 965 may be configured as or otherwise support a means for identifying an on-duration of the on-off keying sample sequence and an off-duration of the on-off keying sample sequence, wherein the on-duration is shorter than the off-duration. In some examples, the cyclic prefix component 965 may be configured as or otherwise support a means for inserting a first sequence of one or more samples having the value of zero at an end of the on-duration of the OOK sample sequence, a second sequence of one or more samples having the value of zero at a beginning of the on-duration, or both. In some examples, a length of the first sequence and the second sequence is based at least in part on a cyclic prefix.

In some examples, to support transmitting the OFDM waveform, the OFDM waveform component 940 may be configured as or otherwise support a means for transmitting, during a symbol period, the OFDM waveform at a transmission power level that is based on a length of an on-duration of the OOK sample sequence and a length of an off-duration of the OOK sample sequence. In some examples, the transmission power level is an average transmission power level that is normalized according to a target transmission power value based on the length of the on-duration relative to the length of the off-duration.

In some examples, the transform component 930 may be configured as or otherwise support a means for applying the transform to the on-off keying sample sequence to generate a third frequency domain sample sequence that comprises the frequency domain sample sequence. In some examples, the mapping component 935 may be configured as or otherwise support a means for shifting a center of the third frequency domain sample sequence to align with a center of the first plurality of resource elements and removing one or more samples of the third frequency domain sample sequence that occur outside of the first plurality of resource elements after the shifting to generate the frequency domain sample sequence.

In some examples, the OOK sample sequence corresponds to a first length, and where an on-duration of the OOK sample sequence includes a sequence of samples having a non-zero value of a second length that is a portion of the first length. In some examples, an off-duration of the OOK sample sequence includes a sequence of samples having a value of zero.

In some cases, the OOK signal component 925, the transform component 930, the mapping component 935, the OFDM waveform component 940, the data sample component 945, the guard band component 950, the IDFT component 955, the Manchester coding component 960, and the cyclic prefix component 965 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the OOK signal component 925, the transform component 930, the mapping component 935, the OFDM waveform component 940, the data sample component 945, the guard band component 950, the IDFT component 955, the Manchester coding component 960, and the cyclic prefix component 965 discussed herein.

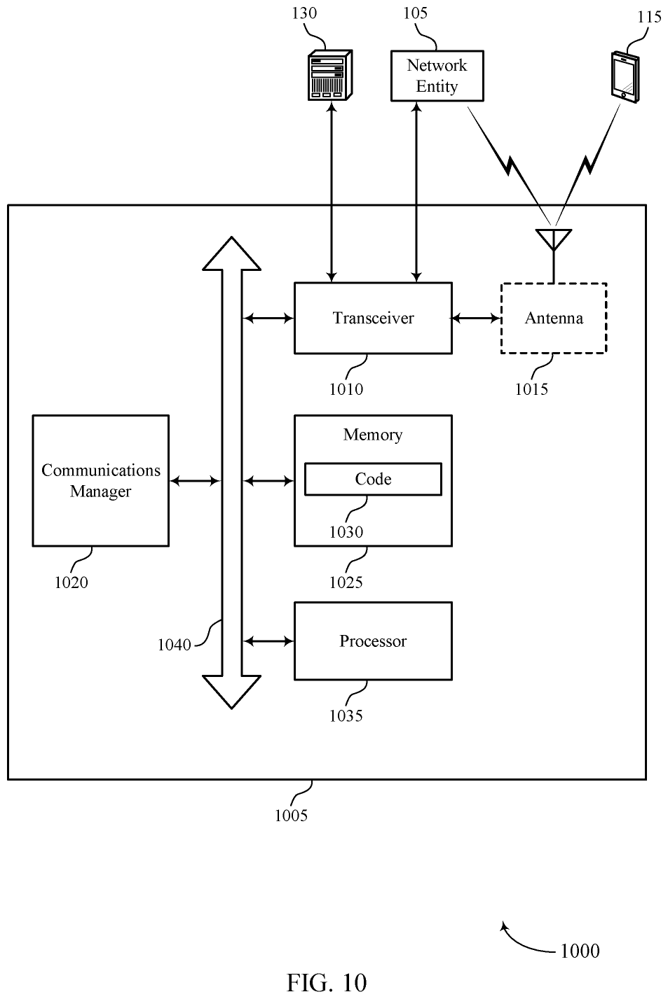

FIG. 10 shows a diagram of a system 1000 including a device 1005 that supports OOK-modulated OFDM waveform generation in accordance with one or more aspects of the present disclosure. The device 1005 may be an example of or include the components of a device 705, a device 805, or a transmitter as described herein. The device 1005 may include components for bi-directional voice and data communications including components for transmitting and receiving communications, such as a communications manager 1020, a transceiver 1010, an antenna 1015, a memory 1025, code 1030, and a processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or memory components (for example, the processor 1035, or the memory 1025, or both), may be included in a chip or chip assembly that is installed in the device 1005. In some examples, the transceiver may be operable to support communications via one or more communications links (e.g., a communication link 125, a backhaul communication link 120, a midhaul communication link 162, a fronthaul communication link 168).

The memory 1025 may include RAM and ROM. The memory 1025 may store computer-readable, computer-executable code 1030 including instructions that, when executed by the processor 1035, cause the device 1005 to perform various functions described herein. The code 1030 may be stored in a non-transitory computer-readable medium such as system memory or another type of memory. In some cases, the code 1030 may not be directly executable by the processor 1035 but may cause a computer (e.g., when compiled and executed) to perform functions described herein. In some cases, the memory 1025 may contain, among other things, a BIOS which may control basic hardware or software operation such as the interaction with peripheral components or devices.

The processor 1035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1035 may be configured to operate a memory array using a memory controller. In some other cases, a memory controller may be integrated into the processor 1035. The processor 1035 may be configured to execute computer-readable instructions stored in a memory (e.g., the memory 1025) to cause the device 1005 to perform various functions (e.g., functions or tasks supporting OOK-modulated OFDM waveform generation). For example, the device 1005 or a component of the device 1005 may include a processor 1035 and memory 1025 coupled with the processor 1035, the processor 1035 and memory 1025 configured to perform various functions described herein. The processor 1035 may be an example of a cloud-computing platform (e.g., one or more physical nodes and supporting software such as operating systems, virtual machines, or container instances) that may host the functions (e.g., by executing code 1030) to perform the functions of the device 1005. The processor 1035 may be any one or more suitable processors capable of executing scripts or instructions of one or more software programs stored in the device 1005 (such as within the memory 1025). In some implementations, the processor 1035 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1035, or the transceiver 1010, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the memory 1025, the code 1030, and the processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X2 interface within an LTE/LTE-A wireless communications network technology to provide communication between network entities 105.

The communications manager 1020 may support wireless communication at a transmitter in accordance with examples as disclosed herein. For example, the communications manager 1020 may be configured as or otherwise support a means for modulating a set of bits into an OOK sample sequence for wireless transmission to a first receiver within a first set of frequency resources. The communications manager 1020 may be configured as or otherwise support a means for applying a transform to the OOK sample sequence to generate a frequency domain sample sequence that is a frequency domain representation of the OOK sample sequence. The communications manager 1020 may be configured as or otherwise support a means for generating an OFDM waveform based on mapping the frequency domain sample sequence to a first set of multiple resource elements within the first set of frequency resources. The communications manager 1020 may be configured as or otherwise support a means for transmitting the OFDM waveform to the first receiver via the first set of frequency resources.

By including or configuring the communications manager 1020 in accordance with examples as described herein, the device 1005 may support techniques for OOK-modulated OFDM waveform generation, which may reduce power consumption, minimize a PAPR of an OFDM signal, and increase spectral efficiency.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, the processor 1035, the memory 1025, the code 1030, or any combination thereof. For example, the code 1030 may include instructions executable by the processor 1035 to cause the device 1005 to perform various aspects of OOK-modulated OFDM waveform generation as described herein, or the processor 1035 and the memory 1025 may be otherwise configured to perform or support such operations.

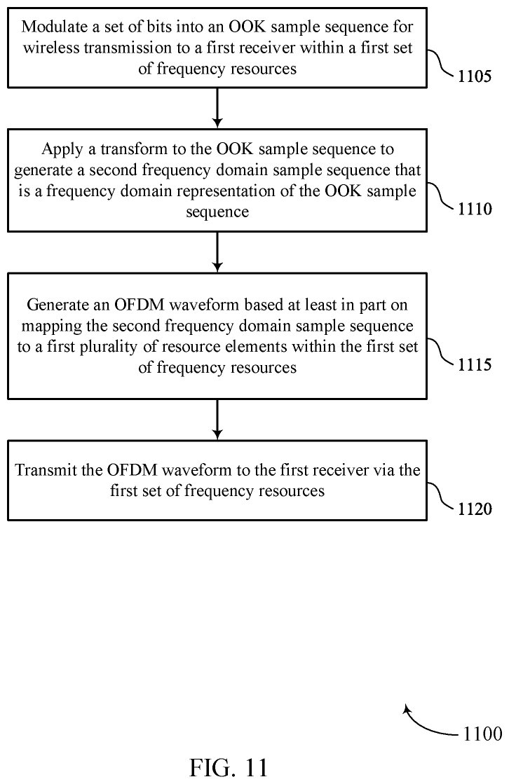

FIG. 11 shows a flowchart illustrating a method 1100 that supports OOK-modulated OFDM waveform generation in accordance with one or more aspects of the present disclosure. The operations of the method 1100 may be implemented by a transmitter or its components as described herein. For example, the operations of the method 1100 may be performed by a transmitter as described with reference to FIGS. 1 through 10. In some examples, a transmitter may execute a set of instructions to control the functional elements of the transmitter to perform the described functions. Additionally, or alternatively, the transmitter may perform aspects of the described functions using special-purpose hardware.

At 1105, the method may include modulating a set of bits into an OOK sample sequence for wireless transmission to a first receiver within a first set of frequency resources. The operations of 1105 may be performed in accordance with examples as disclosed herein. In some examples, aspects of the operations of 1105 may be performed by a OOK signal component 925 as described with reference to FIG. 9.

At 1110, the method may include applying a transform to the OOK sample sequence to generate a frequency domain sample sequence that is a frequency domain representation of the OOK sample sequence. The operations of 1110 may be performed in accordance with examples as disclosed herein. In some examples, aspects of the operations of 1110 may be performed by a transform component 930 as described with reference to FIG. 9.

At 1115, the method may include generating an OFDM waveform based on mapping the frequency domain sample sequence to a first set of multiple resource elements within the first set of frequency resources. The operations of 1115 may be performed in accordance with examples as disclosed herein. In some examples, aspects of the operations of 1115 may be performed by a mapping component 935 as described with reference to FIG. 9.

At 1120, the method may include transmitting the OFDM waveform to the first receiver via the first set of frequency resources. The operations of 1120 may be performed in accordance with examples as disclosed herein. In some examples, aspects of the operations of 1120 may be performed by an OFDM waveform component 940 as described with reference to FIG. 9.

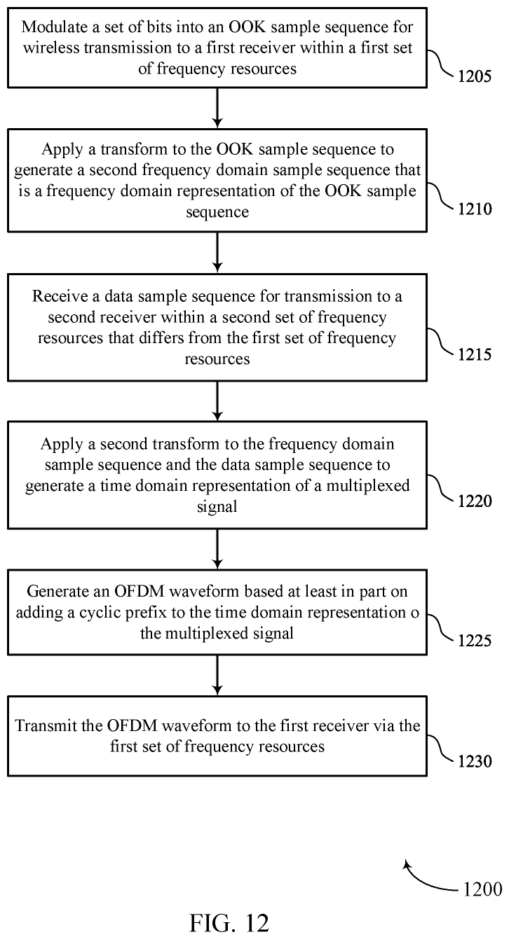

FIG. 12 shows a flowchart illustrating a method 1200 that supports OOK-modulated OFDM waveform generation in accordance with one or more aspects of the present disclosure. The operations of the method 1200 may be implemented by a transmitter or its components as described herein. For example, the operations of the method 1200 may be performed by a transmitter as described with reference to FIGS. 1 through 10. In some examples, a transmitter may execute a set of instructions to control the functional elements of the transmitter to perform the described functions. Additionally, or alternatively, the transmitter may perform aspects of the described functions using special-purpose hardware.

At 1205, the method may include modulating a set of bits into an OOK sample sequence for wireless transmission to a first receiver within a first set of frequency resources. The operations of 1205 may be performed in accordance with examples as disclosed herein. In some examples, aspects of the operations of 1205 may be performed by a OOK signal component 925 as described with reference to FIG. 9.

At 1210, the method may include applying a transform to the OOK sample sequence to generate a frequency domain sample sequence that is a frequency domain representation of the OOK sample sequence. The operations of 1210 may be performed in accordance with examples as disclosed herein. In some examples, aspects of the operations of 1210 may be performed by a transform component 930 as described with reference to FIG. 9.

At 1215, the method may include receiving a data sample sequence for transmission to a second receiver within a second set of frequency resources that differs from the first set of frequency resources. The operations of 1215 may be performed in accordance with examples as disclosed herein. In some examples, aspects of the operations of 1215 may be performed by a data sample component 945 as described with reference to FIG. 9.

At 1220, the method may include applying a second transform to the frequency domain sample sequence and the data sample sequence to generate a time domain representation of a multiplexed signal. The operations of 1220 may be performed in accordance with examples as disclosed herein. In some examples, aspects of the operations of 1220 may be performed by a transform component 930 as described with reference to FIG. 9.

At 1225, the method may include generating an OFDM waveform based on mapping the frequency domain sample sequence to a first set of multiple resource elements within the first set of frequency resources and mapping the data sample sequence to a second set of multiple resource elements within the second set of frequency resources. The operations of 1225 may be performed in accordance with examples as disclosed herein. In some examples, aspects of the operations of 1225 may be performed by a mapping component 935 as described with reference to FIG. 9.

At 1230, the method may include transmitting the OFDM waveform to the first receiver via the first set of frequency resources. The operations of 1230 may be performed in accordance with examples as disclosed herein. In some examples, aspects of the operations of 1230 may be performed by an OFDM waveform component 940 as described with reference to FIG. 9.

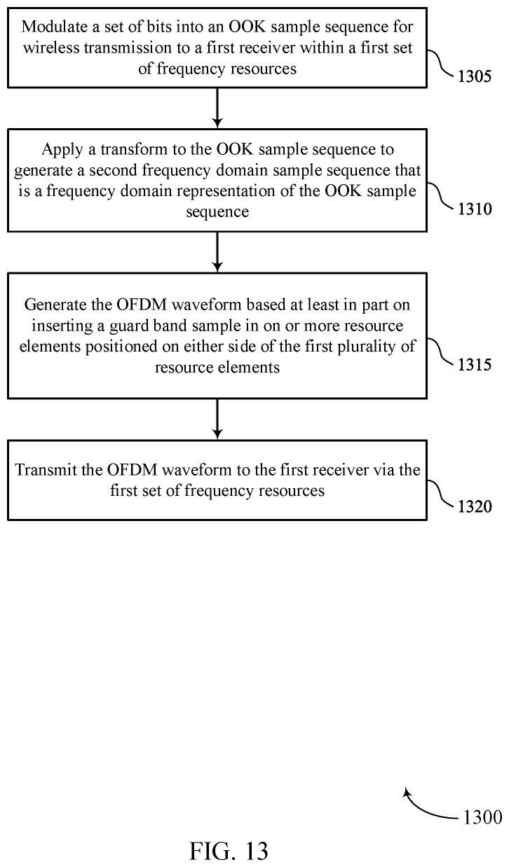

FIG. 13 shows a flowchart illustrating a method 1300 that supports OOK-modulated OFDM waveform generation in accordance with one or more aspects of the present disclosure. The operations of the method 1300 may be implemented by a transmitter or its components as described herein. For example, the operations of the method 1300 may be performed by a transmitter as described with reference to FIGS. 1 through 10. In some examples, a transmitter may execute a set of instructions to control the functional elements of the transmitter to perform the described functions. Additionally, or alternatively, the transmitter may perform aspects of the described functions using special-purpose hardware.

At 1305, the method may include modulating a set of bits into an OOK sample sequence for wireless transmission to a first receiver within a first set of frequency resources. The operations of 1305 may be performed in accordance with examples as disclosed herein. In some examples, aspects of the operations of 1305 may be performed by a OOK signal component 925 as described with reference to FIG. 9.

At 1310, the method may include applying a transform to the OOK sample sequence to generate a frequency domain sample sequence that is a frequency domain representation of the OOK sample sequence. The operations of 1310 may be performed in accordance with examples as disclosed herein. In some examples, aspects of the operations of 1310 may be performed by a transform component 930 as described with reference to FIG. 9.

At 1315, the method may include generating the OFDM waveform based on inserting a guard band sample in one or more resource elements positioned on either side of the first set of multiple resource elements. The operations of 1315 may be performed in accordance with examples as disclosed herein. In some examples, aspects of the operations of 1315 may be performed by a guard band component 950 as described with reference to FIG. 9.

At 1320, the method may include transmitting the OFDM waveform to the first receiver via the first set of frequency resources. The operations of 1320 may be performed in accordance with examples as disclosed herein. In some examples, aspects of the operations of 1320 may be performed by an OFDM waveform component 940 as described with reference to FIG. 9.

The following provides an overview of aspects of the present disclosure:

Aspect 1: A method for wireless communication at a transmitter, comprising: modulating a set of bits into an OOK sample sequence for wireless transmission to a first receiver within a first set of frequency resources: applying a transform to the OOK sample sequence to generate a frequency domain sample sequence that is a frequency domain representation of the OOK sample sequence: generating an OFDM waveform based at least in part on mapping the frequency domain sample sequence to a first plurality of resource elements within the first set of frequency resources: and transmitting the OFDM waveform to the first receiver via the first set of frequency resources.

Aspect 2: The method of aspect 1, further comprising: receiving a data sample sequence for transmission to a second receiver within a second set of frequency resources that differs from the first set of frequency resources: applying a second transform to the frequency domain sample sequence and the data sample sequence to generate a time domain representation of a multiplexed signal: and generating the OFDM waveform based at least in part on adding a cyclic prefix to the time domain representation of the multiplexed signal.

Aspect 3: The method of any of aspects 1 through 2, wherein generating the OFDM waveform comprises: generating the OFDM waveform based at least in part on inserting a guard band sample in one or more resource elements positioned on either side of the first plurality of resource elements.

Aspect 4: The method of any of aspects 1 through 3, wherein applying the transform comprises: applying a DFT to the OOK sample sequence to generate the frequency domain sample sequence.

Aspect 5: The method of any of aspects 1 through 4, wherein generating the OFDM waveform comprises: applying an IDFT to the frequency domain sample sequence to generate the OFDM waveform.

Aspect 6: The method of any of aspects 1 through 5, wherein modulating the set of bits into the OOK sample sequence comprises: identifying an on-duration and an off-duration of the OOK sample sequence based at least in part on the set of bits.

Aspect 7: The method of any of aspects 1 through 6, wherein modulating the set of bits into the OOK sample sequence comprises: modulating an information bit of the set of bits into the OOK sample sequence using Manchester coding.

Aspect 8: The method of any of aspects 1 through 7, further comprising: identifying an on-duration of the OOK sample sequence and an off-duration of the OOK sample sequence, wherein the on-duration is shorter than the off-duration.

Aspect 9: The method of aspect 8, further comprising: inserting a first sequence of the one or more samples having the value of zero at an end of the on-duration of the OOK sample sequence, a second sequence of one or more samples having the value of zero at a beginning of the on-duration, or both.

Aspect 10: The method of aspect 9, wherein a length of the first sequence and the second sequence is based at least in part on a cyclic prefix.

Aspect 11: The method of any of aspects 1 through 10, wherein transmitting the OFDM waveform further comprises: transmitting, during a symbol period, the OFDM waveform at a transmission power level that is based at least in part on a length of an on-duration of the OOK sample sequence and a length of an off-duration of the OOK sample sequence.

Aspect 12: The method of aspect 11, wherein the transmission power level is an average transmission power level that is normalized according to a target transmission power value based at least in part on the length of the on-duration relative to the length of the off-duration.

Aspect 13: The method of any of aspects 1 through 12, wherein the OOK sample sequence corresponds to a first length, and wherein an on-duration of the OOK sample sequence comprises a sequence of samples having a non-zero value of a second length that is a portion of the first length.

Aspect 14: The method of any of aspects 1 through 13, wherein an off-duration of the OOK sample sequence comprises a sequence of samples having a value of zero.

Aspect 15: An apparatus for wireless communication at a transmitter, comprising a processor: memory coupled with the processor: and instructions stored in the memory and executable by the processor to cause the apparatus to perform a method of any of aspects 1 through 14.

Aspect 16: An apparatus for wireless communication at a transmitter, comprising at least one means for performing a method of any of aspects 1 through 14.

Aspect 17: A non-transitory computer-readable medium storing code for wireless communication at a transmitter, the code comprising instructions executable by a processor to perform a method of any of aspects 1 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a transmitter, comprising:
a processor;
memory coupled with the processor; and
instructions stored in the memory and executable by the processor to cause the apparatus to:
modulate a set of bits into an on-off keying sample sequence for wireless transmission to a first receiver within a first set of frequency resources;
apply a transform to the on-off keying sample sequence to generate a frequency domain sample sequence that is a frequency domain representation of the on-off keying sample sequence;
generate an orthogonal frequency division multiplexing waveform based at least in part on mapping the frequency domain sample sequence to a first plurality of resource elements within the first set of frequency resources; and
transmit the orthogonal frequency division multiplexing waveform to the first receiver via the first set of frequency resources.

2. The apparatus of claim 1, wherein the instructions are further executable by the processor to:
receive a data sample sequence for transmission to a second receiver within a second set of frequency resources that differs from the first set of frequency resources;
applying a second transform to the frequency domain sample sequence and the data sample sequence to generate a time domain representation of a multiplexed signal; and
generate the orthogonal frequency division multiplexing waveform based at least in part on adding a cyclic prefix to the time domain representation of the multiplexed signal.

3. The apparatus of claim 1, wherein the instructions are further executable by the processor to generate the orthogonal frequency division multiplexing waveform by being executable by the processor to:
generate the orthogonal frequency division multiplexing waveform based at least in part on inserting a guard band sample in one or more resource elements positioned on either side of the first plurality of resource elements.

4. The apparatus of claim 1, wherein the instructions are further executable by the processor to apply the transform by being executable by the processor to:
apply a discrete Fourier transform to the on-off keying sample sequence to generate the frequency domain sample sequence.

5. The apparatus of claim 1, wherein the instructions are further executable by the processor to generate the orthogonal frequency division multiplexing waveform by being executable by the processor to:
apply an inverse discrete Fourier transform to the frequency domain sample sequence to generate the orthogonal frequency division multiplexing waveform.

6. The apparatus of claim 1, wherein the instructions are further executable by the processor to modulate the set of bits into the on-off keying sample sequence by being executable by the processor to:
identify an on-duration and an off-duration of the on-off keying sample sequence based at least in part on the set of bits.

7. The apparatus of claim 1, wherein the instructions are further executable by the processor to modulate the set of bits into the on-off keying sample sequence by being executable by the processor to:
modulate an information bit of the set of bits into the on-off keying sample sequence using Manchester coding.

8. The apparatus of claim 1, wherein the instructions are further executable by the processor to:
identify an on-duration of the on-off keying sample sequence and an off-duration of the on-off keying sample sequence, wherein the on-duration is shorter than the off-duration.

9. The apparatus of claim 8, wherein the instructions are further executable by the processor to:
insert a first sequence of one or more samples having a value of zero at an end of the on-duration of the on-off keying sample sequence, a second sequence of one or more samples having the value of zero at a beginning of the on-duration, or both.

10. The apparatus of claim 9, wherein a length of the first sequence and the second sequence is based at least in part on a cyclic prefix.

11. The apparatus of claim 1, wherein the instructions are further executable by the processor to transmit the orthogonal frequency division multiplexing waveform by being further executable by the processor to:
transmit, during a symbol period, the orthogonal frequency division multiplexing waveform at a transmission power level that is based at least in part on a length of an on-duration of the on-off keying sample sequence and a length of an off-duration of the on-off keying sample sequence.

12. The apparatus of claim 11, wherein the transmission power level is an average transmission power level that is normalized according to a target transmission power value based at least in part on the length of the on-duration relative to the length of the off-duration.

13. The apparatus of claim 1, wherein the instructions to apply the transform to the on-off keying sample sequence to generate the frequency domain sample sequence are further executable by the processor to:
apply the transform to the on-off keying sample sequence to generate a third frequency domain sample sequence that comprises the frequency domain sample sequence: and
shift a center of the third frequency domain sample sequence to align with a center of the first plurality of resource elements and remove one or more samples of the third frequency domain sample sequence that occur outside of the first plurality of resource elements after the shifting to generate the frequency domain sample sequence.

14. The apparatus of claim 1, wherein the on-off keying sample sequence corresponds to a first length, and wherein an on-duration of the on-off keying sample sequence comprises a sequence of samples having a non-zero value of a second length that is a portion of the first length.

15. The apparatus of claim 1, wherein an off-duration of the on-off keying sample sequence comprises a sequence of samples having a value of zero.

16. A method for wireless communication at a transmitter, comprising:
modulating a set of bits into an on-off keying sample sequence for wireless transmission to a first receiver within a first set of frequency resources:
applying a transform to the on-off keying sample sequence to generate a frequency domain sample sequence that is a frequency domain representation of the on-off keying sample sequence:
generating an orthogonal frequency division multiplexing waveform based at least in part on mapping the frequency domain sample sequence to a first plurality of resource elements within the first set of frequency resources; and
transmitting the orthogonal frequency division multiplexing waveform to the first receiver via the first set of frequency resources.

17. The method of claim 16, further comprising:
receiving a data sample sequence for transmission to a second receiver within a second set of frequency resources that differs from the first set of frequency resources;
applying a second transform to the frequency domain sample sequence and the data sample sequence to generate a time domain representation of a multiplexed signal; and
generating the orthogonal frequency division multiplexing waveform based at least in part on adding a cyclic prefix to the time domain representation of the multiplexed signal.

18. The method of claim 16, wherein generating the orthogonal frequency division multiplexing waveform comprises:
generating the orthogonal frequency division multiplexing waveform based at least in part on inserting a guard band sample in one or more resource elements positioned on either side of the first plurality of resource elements.

19. The method of claim 16, wherein applying the transform comprises:
applying a discrete Fourier transform to the on-off keying sample sequence to generate the frequency domain sample sequence.

20. The method of claim 16, wherein generating the orthogonal frequency division multiplexing waveform comprises:
applying an inverse discrete Fourier transform to the frequency domain sample sequence to generate the orthogonal frequency division multiplexing waveform.

21. The method of claim 16, wherein modulating the set of bits into the on-off keying sample sequence comprises:
identifying an on-duration and an off-duration of the on-off keying sample sequence based at least in part on the set of bits.

22. The method of claim 16, wherein modulating the set of bits into the on-off keying sample sequence comprises:
modulating an information bit of the set of bits into the on-off keying sample sequence using Manchester coding.

23. The method of claim 16, further comprising:
identifying an on-duration of the on-off keying sample sequence and an off-duration of the on-off keying sample sequence, wherein the on-duration is shorter than the off-duration.

24. The method of claim 23, further comprising:
inserting a first sequence of one or more samples having a value of zero at an end of the on-duration of the on-off keying sample sequence, a second sequence of one or more samples having the value of zero at a beginning of the on-duration, or both.

25. The method of claim 24, wherein a length of the first sequence and the second sequence is based at least in part on a cyclic prefix.

26. The method of claim 16, wherein transmitting the orthogonal frequency division multiplexing waveform further comprises:
transmitting, during a symbol period, the orthogonal frequency division multiplexing waveform at a transmission power level that is based at least in part on a length of an on-duration of the on-off keying sample sequence and a length of an off-duration of the on-off keying sample sequence.

27. The method of claim 26, wherein the transmission power level is an average transmission power level that is normalized according to a target transmission power value based at least in part on the length of the on-duration relative to the length of the off-duration.

28. The method of claim 16, further comprising:
applying the transform to the on-off keying sample sequence to generate a third frequency domain sample sequence that comprises the frequency domain sample sequence: and
shifting a center of the third frequency domain sample sequence to align with a center of the first plurality of resource elements and removing one or more samples of the third frequency domain sample sequence that occur outside of the first plurality of resource elements after the shifting to generate the frequency domain sample sequence.

29. A non-transitory computer-readable medium storing code for wireless communication at a transmitter, the code comprising instructions executable by a processor to:
modulate a set of bits into an on-off keying sample sequence for wireless transmission to a first receiver within a first set of frequency resources:
apply a transform to the on-off keying sample sequence to generate a frequency domain sample sequence that is a frequency domain representation of the on-off keying sample sequence:
generate an orthogonal frequency division multiplexing waveform based at least in part on mapping the frequency domain sample sequence to a first plurality of resource elements within the first set of frequency resources; and
transmit the orthogonal frequency division multiplexing waveform to the first receiver via the first set of frequency resources.

30. An apparatus for wireless communication at a transmitter, comprising:
means for modulating a set of bits into an on-off keying sample sequence for wireless transmission to a first receiver within a first set of frequency resources;
means for applying a transform to the on-off keying sample sequence to generate a frequency domain sample sequence that is a frequency domain representation of the on-off keying sample sequence;
means for generating an orthogonal frequency division multiplexing waveform based at least in part on mapping the frequency domain sample sequence to a first plurality of resource elements within the first set of frequency resources; and
means for transmitting the orthogonal frequency division multiplexing waveform to the first receiver via the first set of frequency resources.
